(19) United States
(12) Patent Application Publication
(10) Pub. No.: US 2017/0204991 A1
(43) Pub. Date: Jul. 20, 2017

(54) Valve anti-theft device

(71) Applicant: Paul F. Pittman, Bloomington, MN (US)

(72) Inventor: Paul F. Pittman, Bloomington, MN (US)

(21) Appl. No.: 14/545,993

(22) Filed: Jul. 15, 2015

Related U.S. Application Data
(60) Provisional application No. 61/999,106, filed on Jul. 16, 2014.

(51) Int. Cl. F16K 51/00; E03B 9/02

(52) U.S. Cl. CPC F16K 51/00; E03B 9/02

(57) ABSTRACT

A valve anti-theft system, for use in conjunction with valves mounted to a side arm extending from a standpipe. The system includes a plate configured for mounting to a valve located surrounding the shaft of a valve control ring and against a surface of the valve and one or more rods extending from the plate and configured to extend toward the standpipe alongside the valve. The system further includes a mounting mechanism for securing the elongated members to the standpipe or side arm. The mounting means includes a flange configured to extend from the standpipe or side arm, generally perpendicular the axis of the side arm and having a hole through which an end of a said rod passes, the end of said rod being threaded and fastenable to the flange by means of an associated nut.

### FIELD

This invention generally relates to a device for preventing theft of valves. In particular, the invention relates to a mechanism for preventing removal of valves from standpipes.

### BACKGROUND

Recently, thefts of brass valves, particularly those mounted to standpipes on publicly available areas of buildings such as parking garages, has increased dramatically. There is typically no water in these standpipes. The valves typically contain a substantial amount of brass. They are readily removed in a few seconds by simply unscrewing them from their associated threaded fitting on the standpipe. These factors together make theft of the valves an easy, profitable activity.

Unfortunately, in the absence of the valves, the fire department cannot use the standpipes to deliver water to fight a fire in the associated structure. This means that the valves must be promptly replaced, at a substantial cost to the owner. The present invention is intended to make it unauthorized removal of the valves sufficiently difficult to make their theft unattractive to the would-be thieves.

### SUMMARY OF THE INVENTION

The valves of interest are typically mounted to the standpipe on a threaded fitting on the end of a side-arm extending at a right angle from the standpipe. The valves are typically provided with a control wheel on a shaft extending along the axis of the side-arm. The control wheel controls flow of water from the side-arm to the outlet of the valve, also provided with a threaded fitting. This threaded fitting of the valve outlet is typically sealed with a removable threaded cover. The cover is unscrewed from the outlet in order to allow attachment of a fire hose.

Typically the valve housing has a generally flat end surface perpendicular to the axis of the shaft. The shaft is typically surrounded by a tubular enclosure extending from this surface, and which carries a compression seal therein. The flat end surface is typically substantially larger than the tubular enclosure.

The present invention generally take the form of a plate having an opening to be mounted around the tubular enclosure surrounding the shaft of the control wheel and located against the end surface of the valve. The plate typically extends radially outward of the end surface, and is coupled to one or more rods extending therefrom alongside the valve housing and back towards the standpipe. The rod or rods are provided with a mechanism for their attachment to the standpipe or the side-arm, preventing removal of the valve by unscrewing.

In one embodiment, most commonly used when the side-arm is simply welded to the side of the standpipe, the rod or rods are coupled to a saddle that is located against the side of the standpipe, opposite the side-arm. Together, the assembly prevents the valve from being removed unless the rods are disconnected from the saddle. The saddle is provided with outwardly extending flanges that are generally perpendicular to the axis of the side-arm. Each flange is provided with a hole through which the threaded rod passes. The rods are typically threaded and retained to the flanges of the saddle by means of locknuts of the type that require a special wrench for their removal, similar to those used to secure the expensive aluminum wheels used on cars and trucks. Such nuts may have a set of external splines and recesses arranged around the outer surface of the nut, having variable spacing and widths. Removing them is accomplished by means of a corresponding removal wrench, having its own set of splines and recesses corresponding to the inverse of the nut. The wrench may take the form of a cylindrical socket.

In order to prevent removal of the nuts by means of a pliers, pipe wrench, or the like, each flange of the saddle is provided with a tubular housing extending perpendicular to the flange and around the nut and preventing access to the nut from its sides. Preferably, the tubular housing on the flange is radially spaced from the nut so that a relatively close fit is obtained to the associated tubular socket of the removal wrench.

A second embodiment of the invention is used in those situations in which the side-arm is coupled to the standpipe by means of a circumferential collar, extending around the standpipe. In these cases, the collar typically comprises two components, a first component extending about halfway around the standpipe and carrying the side-arm, the second component extending around the opposite side of the standpipe and secured to the first component by means of nuts and bolts which pull the two pieces together to tightly fasten them around the standpipe and seal the side-arm thereto. In these cases, there are typically gaps between the two components, across which the bolts securing the two components together extend: The bolts extend generally parallel to the axis of the side-arm.

In the second embodiment, rather than a saddle, each rod is secured to an individual flange which is located between the collar components and through which a bolt holding the collar components together passes. The flanges extend generally perpendicular to the axis if the side-arm, like the flanges of the saddle described above in conjunction with the first embodiment. Each flange is provided with a tubular housing surrounding a bore through which the threaded rod extends, extending perpendicular to the flange as described above in conjunction with the saddle employed by the first embodiment.

In some cases, the side-arm itself may be surrounded by a two-piece collar. In this case, a third embodiment of the invention may employ flanges mounted to this collar, rather the located adjacent the standpipe as in the first two embodiments. In such cases, the bolts holding the two components of the collar together will be parallel to the axis of the side-arm. The flanges may be L-shaped, with one portion, through which the bolt holding the collar components together extending generally in a plane parallel to the axis of the side-arm and a second portion generally perpendicular thereto, having the hole through which the threaded rod extends and the associated tubular housing corresponding to those of the first and second embodiments described above. Additional variations of the invention may be adapted to deal with other configurations of the standpipe, side-arm and valve as needed.

Because of the wide number of configurations available for the nuts and removal wrenches, it is extremely unlikely that a prospective thief would be able to unscrew the nuts and then remove the valve.

### BRIEF DESCRIPTION OF THE DRAWINGS

Aspects and features of the present invention will be appreciated as the same becomes better understood by reference to the following detailed description of the embodiments of the invention when considered in connection with the accompanying drawings, wherein:

FIG. 1 is an a perspective view of a valve and standpipe of the type used with the first embodiment of the invention.

FIG. 2 is a perspective view of a valve and standpipe of the type used with the second embodiment of the invention.

FIG. 3 is a perspective view of a valve and standpipe of the type used with the third embodiment of the invention.

FIG. 4A is a plan drawing of the first embodiment of the present invention as mounted to a valve and standpipe as shown in FIG. 1.

FIG. 4B is a perspective view showing the first embodiment of the present invention as mounted to a valve and standpipe as shown in FIG. 1.

FIG. 5 is a plan view showing the saddle of FIG. 4A as mounted to the standpipe.

FIG. 6 is a sectional view through the saddle of FIG. 5, illustrating the relationship of the tubular housing, rod and locknut.

FIG. 7 is a perspective view of the plate and associated rods as illustrated in FIG. 4A.

FIG. 8 is a perspective view of a locknut as used with all three embodiments of the invention.

FIG. 9 is a perspective view of a locknut removal socket as used with all three embodiments of the invention.

FIG. 10A is a plan drawing of the second embodiment of the present invention as mounted to a valve and standpipe as shown in FIG. 2.

FIG. 10B is a perspective view showing the second embodiment of the present invention as mounted to a valve and standpipe as shown in FIG. 2.

FIG. 11 is a plan view showing the flanges of FIG. 10A as mounted to the standpipe.

FIGS. 12A and 12B are side and end views, respectively, of a flange adapted for use with the valve and standpipe of FIG. 3 in conjunction with a third embodiment of the invention.

### DETAILED DESCRIPTION

In the figures as described below, numbered components on each drawing are the same component as identically numbered components on the other drawings. All numbered components will not be described separately for each figure.

Further, the structure of the control valves and many other related structures in all described embodiments is essentially the same. For purposes of efficiency, therefore, numbered components in each figure having the same last two digits, e.g. 12, 112, 212, etc. should be understood to have the same or equivalent structures and functions. With this convention, description of the figures can be set forth more concisely.

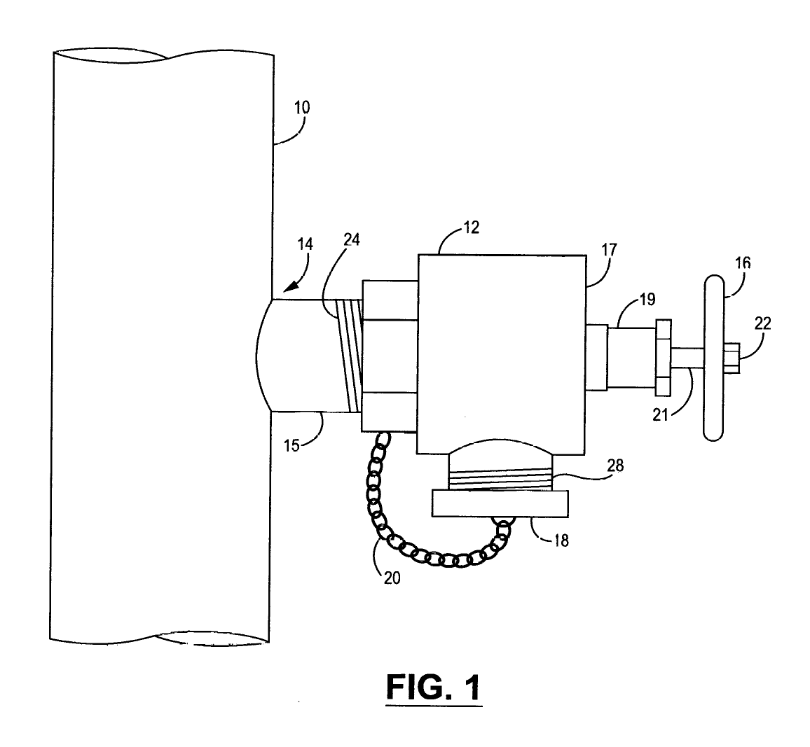

FIG. 1 is a perspective view of a valve and standpipe of the type used with the first embodiment of the invention. Standpipe 10 extends vertically and is typically coupled to a water inlet fitting external to the building, to which a source of pressurized water can be coupled. A tee 14 is shown, with a side-arm 15, extending horizontally from the standpipe 10, generally perpendicular to the axis of the standpipe. A threaded end 24 is provided, to which valve 12 is screwed. Valve 12 is provided with a valve outlet 28, to which water from the standpipe is delivered under control of control wheel 16.

Valve outlet 28 is provided with a protective cover 18, secured to the valve by chain 20. Control wheel 16 is mounted to shaft 21, located within tubular enclosure 19, extending from end surface 17 of the valve housing. As shown, end surface 17 is general flat and extends radially outward of tubular housing 19. Control wheel 16 is secured to the shaft 21 by means of a nut 22.

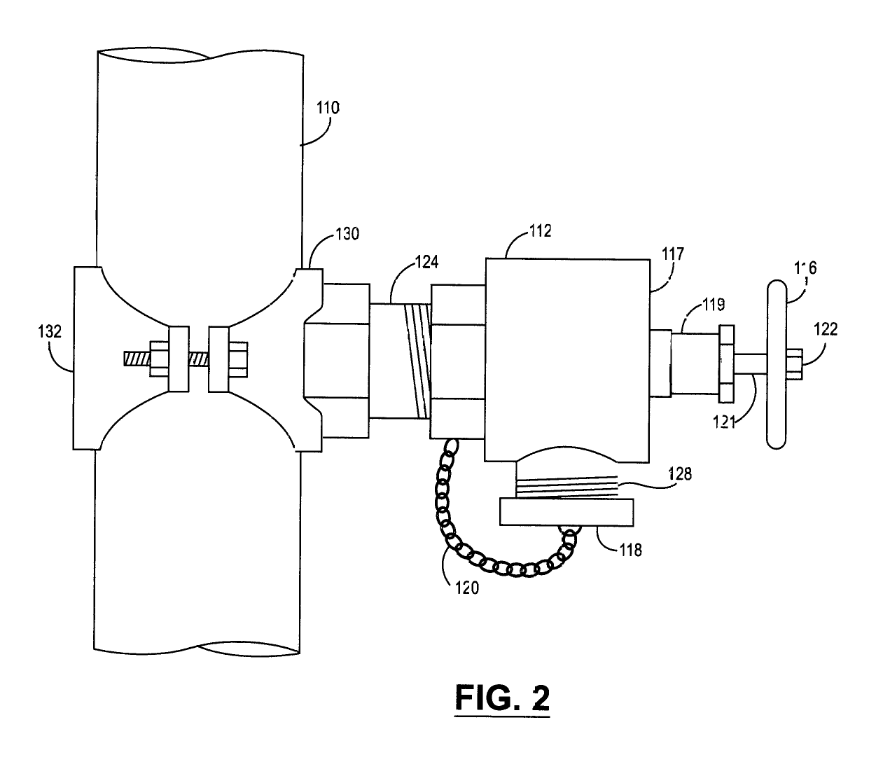

FIG. 2 is a perspective view of a valve and standpipe of the type used with the second embodiment of the invention. The valve and standpipe correspond to those of FIG. 1, with the exception that the tee 114 is formed by a collar assembly comprising a first component 130, carrying the side-arm and a second component 132, located on the opposite side of the standpipe 110. The collar components are secured to one another by means of bolts 134 connecting their adjacent ends, compressing the components against the standpipe. As shown, there is a gap between the adjacent ends of the collar components, bridged by the bolt 134. As discussed above, this gap provides the location for the flanges of the second embodiment of the invention.

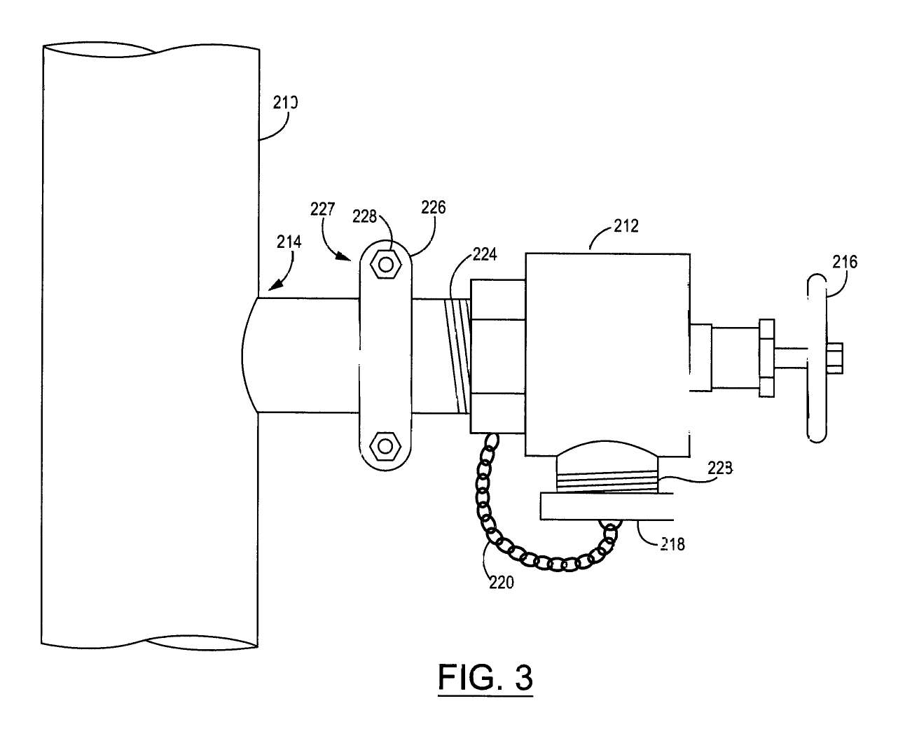

FIG. 3 is a perspective view of a valve and standpipe of the type used with the third embodiment of the invention. The valve and standpipe correspond to those of FIG. 1, with the exception that the side-arm is provided with a circumferential collar assembly comprising a first component 226, and a second component 227, located on the opposite side of the side-arm. The collar components are secured to one another by means of bolts 228 (and associated nuts) connecting their adjacent ends, compressing the components against the standpipe. As shown, there is a gap between the adjacent ends of the collar components, bridged by the bolt 228. As discussed above, this gap provides the location for the flanges of the third embodiment of the invention.

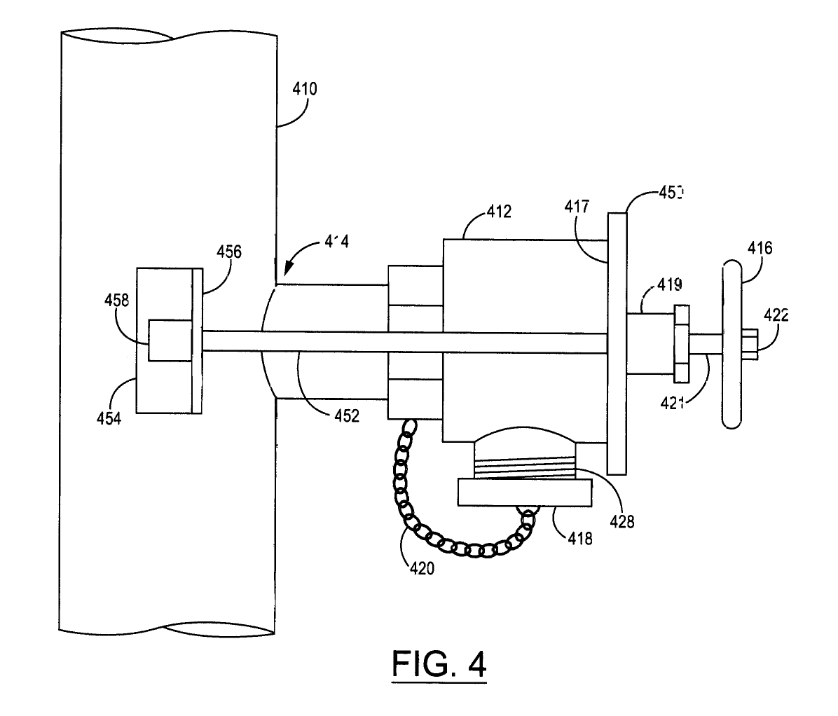

FIG. 4A is a plan drawing of the first embodiment of the present invention as mounted to a valve and standpipe as shown in FIG. 1. Additional components include circular plate 450, having a central opening located encircling tubular enclosure 419 and lying against end surface 417 of the housing of valve 412. Rods 452 are welded to plate 450 and extend alongside the housing of valve 412 generally parallel to the axis of the sidearm to saddle 454. Saddle 454 extends around the side of standpipe 419 opposite the side-arm and is provided with outwardly extending flanges 456 on either side of the standpipe.

Flanges 456 are generally perpendicular to the axis of the sidearm and are each provided with a hole through which the end of a rod 452 passes. Rods 452 have threaded ends and are retained to flanges 456 by locknuts as described above. Welded to each flange is a tubular enclosure 458, surrounding the hole in each flange and spaced radially outward of the locknut within, preventing access to the locknut other than by its associated wrench socket as discussed above.

Plate 450 and rods 452 are mounted by first removing control wheel 416 and then placing the plate against end surface 417 with tubular enclosure 419 extending the opening through the opening through plate 450. The saddle is slid over the ends of the rods 452 and secure thereto by means of the locknuts, and the control wheel is re-attached to shaft 412, completing the installation process.

FIG. 4B is a perspective view showing the first embodiment of the present invention as mounted to a valve and standpipe as shown in FIG. 4A.

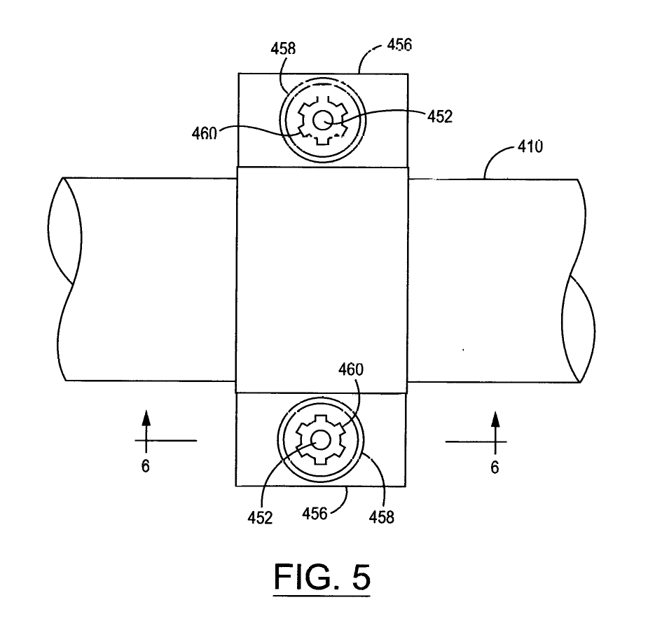

FIG. 5 is a plan view showing the saddle of FIG. 4A as mounted to the standpipe as viewed from the side opposite to the sidearm. In this view, the splined locknuts 460 can be seen located as screwed onto the ends of threaded rods 452 and surrounded by tubular housings 458

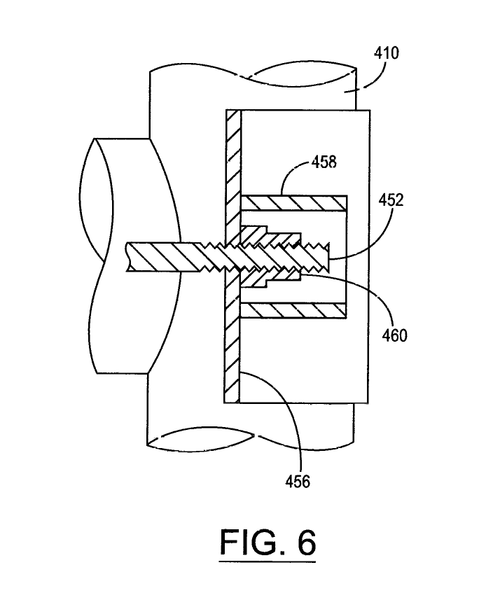

FIG. 6 is a sectional view through the saddle of FIG. 5, illustrating the relationship of the tubular housing, rod and locknut. In this view it can be seen how the tubular housing 458 defines an opening for the associated locknut wrench socket to access the locknut 460, while preventing access to the locknut from the side. As discussed above, the spacing between the housing 458 and locknut 460 should be such that the associated wrench socket fits fairly closely to the interior surface of tubular enclosure 458, making access by other tools less likely.

The basic relationship of the threaded rods, flanges, tubular housings and locknuts as described in conjunction with the first embodiment of the invention should be understood to apply to the second and third embodiments of the invention, as disclosed below.

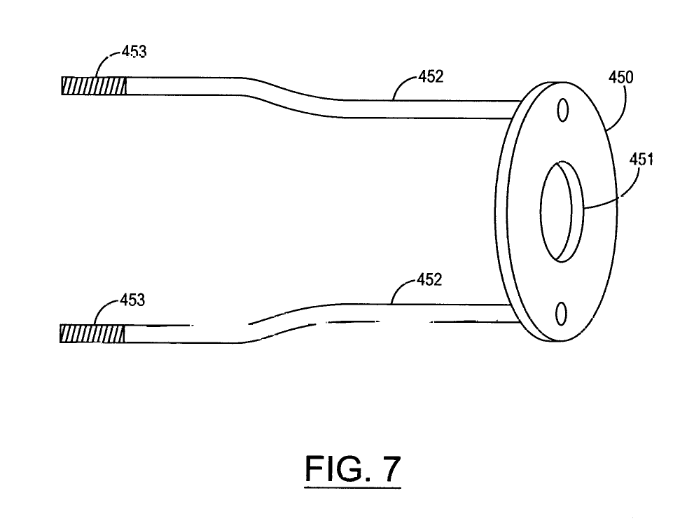

FIG. 7 is a perspective view of the plate and associated rods as illustrated in FIG. 4A. In this view, the opening 451 through plate 450 is visible. As mounted, the tubular enclosure 419 of the valve housing extends through tis opening. Also visible is the fact that threaded rods 452 are each provided with an outwardly extending curved section. This feature may be present wherever the distance between the holes through the flanges is greater than the distance between the points of attachment of the rods to plate 450. The threaded ends 453 of the rods 452 are also shown. The rods are preferably attached to the plate by locating them within corresponding holes through the plate and thereafter welding them to the plate. The plate and rod assembly as illustrated is employed in conjunction with all three described embodiments of the invention.

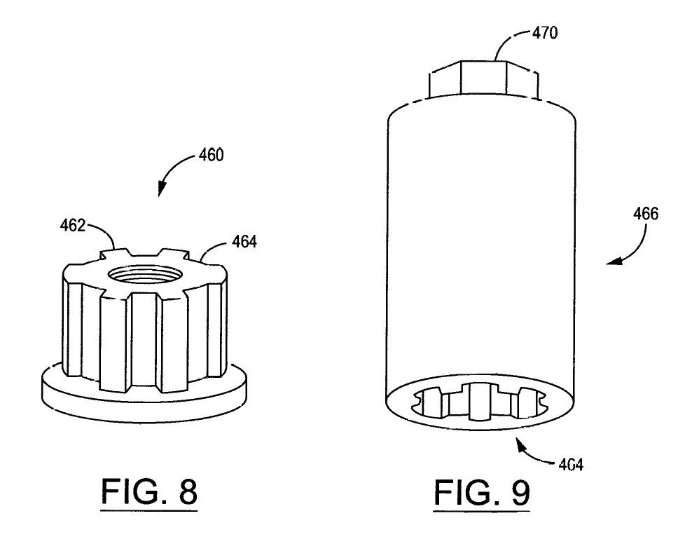

FIG. 8 is a perspective view of a locknut as used with all three embodiments of the invention. As shown, the nut 460 is provided with splines 462 separated by recesses 464, arrayed around the circumference of the nut. Both the thickness of the splines and the widths of the spacings can be varied, providing for a large number of different configurations, each of which can be engaged only by means of a correspondingly constructed socket having the inverse configuration of splines and recesses on its interior surface. Typically, all of the anti-theft systems installed in a single building will have the same locknut configuration, simplifying the owner's access to the valves.

Alternative types of locknuts and associated removal tools may also be substituted. A wide variety of such locknuts and associated wrenches or other removal tools are available commercially, any no specific locknut design is essential to practicing the invention.

FIG. 9 is a perspective view of a locknut removal socket 466 as used with all three embodiments of the invention. The interior surface 468 of the socket is provided with splines and spacings which are the inverse of those on the nut 460. The proximal end is provided with a fitting 470 allowing engagement of the socket with a handle or with a conventional wrench, as desired.

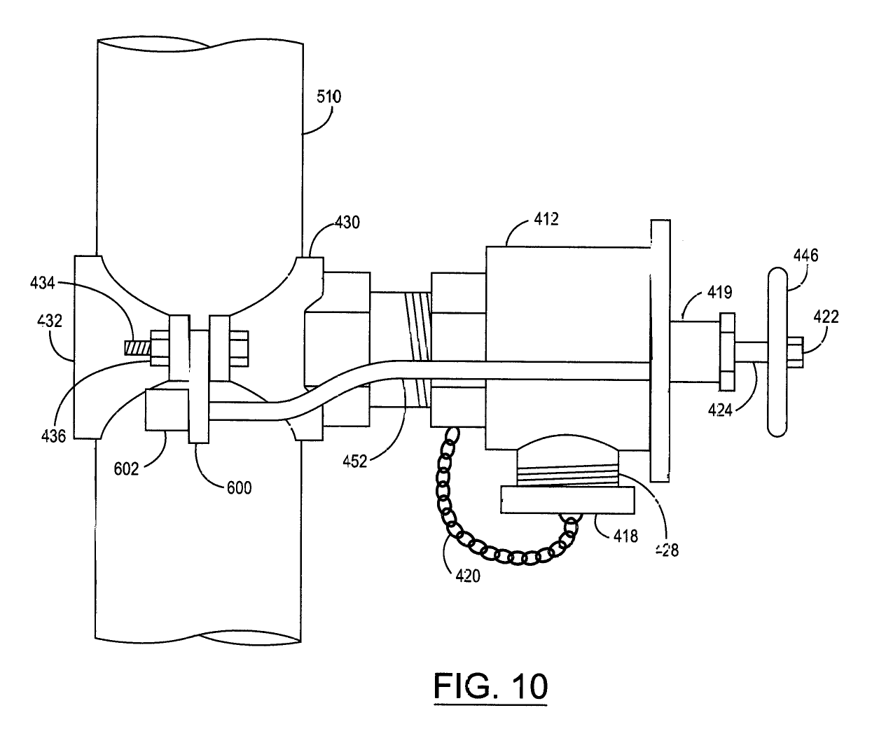

FIG. 10A is a plan drawing of the second embodiment of the present invention as mounted to a valve and standpipe 510 corresponding to that shown in FIG. 2. This embodiment of the invention differs from that of FIG. 4A in that two separate flanges 600 are provided, located between collar components 430 and 432 and held in place by bolts 434, passing through corresponding holes through the flanges 600. Each flange 600 is provided with a holes through which the threaded end of a rod 452 extends and is provided with a tubular housing 612, corresponding to the tubular housings 458, illustrated in FIG. 4A. A locknut within tubular housing 602 secures the rod 452 to the flange 600, in the same manner as discussed in conjunction with the embodiment of FIG. 4A.

FIG. 10B is a perspective view showing the second embodiment of the present invention as mounted to a valve and standpipe as shown in FIG. 2.

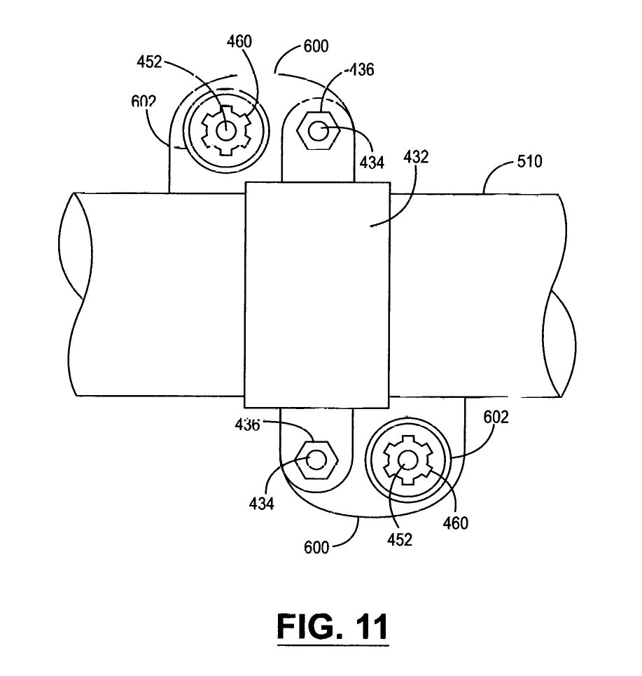

FIG. 11 is a plan view showing the flanges of FIG. 10A as mounted to the standpipe as viewed from the side of the standpipe 510 opposite to the side arm. This view illustrates the configuration of the flanges 600 and the tubular housings 602. The inter-relation of the flanges, the tubular housings, the locknuts and the rods is functionally the same as illustrated in FIGS. 4-6.

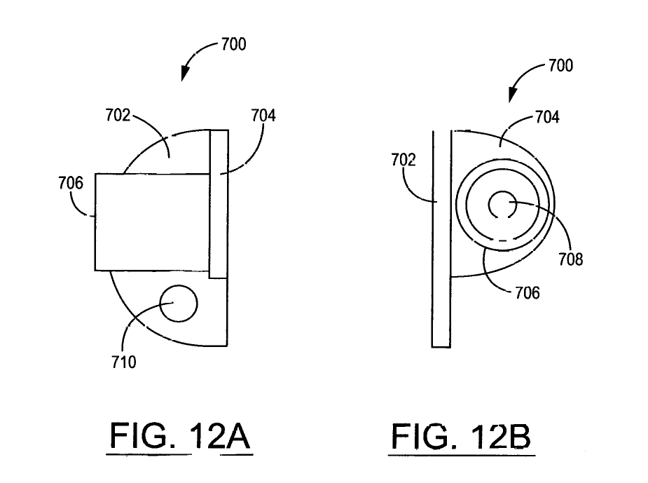

FIGS. 12A and 12B are side and end views, respectively, of a flange adapted for use with the valve and standpipe of FIG. 3 in conjunction with a third embodiment of the invention, for use in conjunction with valve and standpipe configurations as shown in FIG. 3. The flange 700 is a folded plate having a base portion 702 and a tab portion 704 roughly perpendicular thereto. The base portion is provided with a hole 710 through which the bolt 228 (FIG. 3) extends, with base 702 mounted between the collar components 226 and 227 (FIG. 3). As mounted, base 703 lies in a plane roughly parallel to the axis of the side arm. Tab 704 carries a tubular housing 706, surrounding hole 708 corresponding to the tubular housings described in conjunction with the first and second embodiments of the invention as described above. Flanges 700 are employed in conjunction with the plate and rod assembly of FIG. 7, and connected thereto by locknuts in the same manner as described in conjunction with the first and second embodiments described above.

The components of the anti-theft device are preferably made of a hard metal, resistant to cutting by hacksaws or bolt cutters. Hardened steel may be employed. In areas in which corrosion may be a problem, stainless steel may be employed. Other metals or other non-metallic materials may be substituted if appropriate.

As dimensions of the standpipes and associated valves vary, dimensions of the components will of necessity be chosen to conform to the specific configuration of the standpipe and valve. To this end, an inventory of a variety of differently sized components may be desirable to simplify installation.

While the preferred embodiment as disclosed herein is adapted for use in containing the rearward universal joint adjacent the differential, the device may also be adaptable for use in other locations, adjacent other driveline devices such as the rear end of a transmission or the like. As such, the above disclosure should be considered exemplary of the invention as claimed below.

In conjunction with the above disclosure, I claim the invention as set forth below.

I claim:

1. A valve anti-theft system, for use in conjunction with valves mounted to a side arm extending from a standpipe, comprising:
a plate configured for mounting to a valve located surrounding the shaft of a valve control ring and against a surface of the valve;
one or more elongated members or rods extending from the plate and configure to extend toward the standpipe alongside the valve; and
mounting means for securing the elongated members to the standpipe or side arm.

2. A system according to claim 1, wherein the mounting means comprises a flange configured to extend from the standpipe or side arm, generally perpendicular the axis of the side arm and having a hole through which an end of a said rod passes, the end of said rod being threaded and fastenable to the flange by means of an associated nut.

3. A system according to claim 2 wherein the flange is provided with a tubular enclosure configured to surround the nut, preventing side access to the nut.

4. A system according to claim 3 wherein the nut takes the form of a lock not having external features engageable only with a corresponding tool.

5. A system according to claim 4 wherein the locknut is provided with a set of external splines having variable thicknesses and/or separated by variable spacings and wherein the corresponding tool takes the form of a wrench socket have corresponding inversely arranges splines and spacings, engageable with the locknut.

6. A system according to claim 1, wherein the mounting means comprises a saddle configured to engage a side of the standpipe opposite to the side-arm.

7. A system according to claim 1 wherein the mounting means comprises individual flanges configured to be secured between components of a collar encircling the standpipe or the side arm.

8. A method for preventing valve theft in conjunction with valves mounted to a side arm extending from a standpipe, comprising:
mounting a plate to a valve, located surrounding the shaft of a control ring of the valve and against a surface of the valve;
mounting one or more elongated members or rods extending from the plate and extending toward the standpipe alongside the valve; and
mounting a means for securing the elongated members to the standpipe or side arm.

9. A method according to claim 8, wherein the securing means comprises a flange configured to extend from the standpipe or side arm, generally perpendicular the axis of the side arm and having a hole through which an end of a said rod passes, and wherein mounting the securing means comprises fastening the end of said rod to the flange by means of an associated nut.

10. A method according to claim 9 wherein the flange is provided with a tubular enclosure configured to surround the nut, preventing side access to the nut.

11. A method according to claim 10 wherein the nut takes the form of a lock not having external features engageable only with a corresponding tool.

12. A method according to claim 11 wherein the locknut is provided with a set of external splines having variable thicknesses and/or separated by variable spacings and wherein the corresponding tool takes the form of a wrench socket have corresponding inversely arranges splines and spacings, engageable with the locknut.

13. A method according to claim 8 wherein the securing means comprises a saddle configured to engage a side of the standpipe opposite to the side-arm.

14. A method according to claims 8 wherein the securing means comprises individual flanges configured to be secured between components of a collar encircling the standpipe or the side arm.
